(19) United States
(12) Patent Application Publication
(10) Pub. No.: US 2021/0174430 A1
(43) Pub. Date: Jun. 10, 2021

(54) BASE TYPE ORDER PAYMENT SYSTEM AND METHOD FOR OMNI-CHANNEL SHOPPING

(71) Applicant: CREFUN CO., LTD., Mokpo-si (KR)

(72) Inventor: Ji Woong LEE, Jeollanam-do (KR)

(73) Assignee: CREFUN CO., LTD., Mokpo-si (KR)

(21) Appl. No.: 17/082,631

(22) Filed: Oct. 28, 2020

(30) Foreign Application Priority Data
Dec. 9, 2019 (KR) 10-2019-0162650

(51) Int. Cl. G06Q 30/06; G06Q 20/02; G06Q 20/32; G06Q 20/18; G06K 7/10; G06Q 20/40; G06Q 10/08; G06Q 10/06; G06F 3/044

(52) U.S. Cl. CPC G06Q 30/0635; G06Q 20/02; G06Q 20/3276; G06Q 20/18; G06K 7/1095; G06Q 20/326; G06Q 50/14; G06Q 10/0875; G06Q 10/083; G06Q 10/06315; G06Q 30/0639; G06F 3/044; G06Q 20/40145

(57) ABSTRACT

Disclosed are a base type order payment system and method for omni-channel shopping. The base type order payment system for omni-channel shopping may include an order server constructed at a specific place, such as a hotel, a shopping center or an apartment house, and configured to provide a list of articles or products to a mobile terminal of an orderer in order to induce payment, base servers placed in respective areas and configured to receive order data from the order server, and a payment server configured to perform payment processing on the ordered product or article through a QR code included in the order data received from the base server.

### BACKGROUND

### 1. Technical Field

The present disclosure relates to a base type order payment system and method for omni-channel shopping, and more particularly, to a base type order payment system and method for omni-channel shopping, which enable a tourist who travels around an area of a country to conveniently order and use a product necessary at the base of the country, to check information on a list of products sold in the country, and to conveniently receive a product purchased during the shopping at a place, such as accommodations, while traveling around several domestic and foreign places.

### 2. Related Art

In general, in the case of an online shopping mall managed in an omni-channel shopping manner, in many cases, multiple servers do not actively handle explosive order data attributable to a flood of product orders by orderers, so that a payment server does not perform payment processing on the ordered products related to the explosive order data at a proper time. Accordingly, it frequently takes a considerable time to deliver ordered products, thereby resulting in delivery delay.

Above all, multiple servers that receive the explosive order data have different traffic bottleneck phenomena depending on their specifications and thus are difficult to properly integrate and manage. Accordingly, the payment processing of a payment server that performs payment processing on the ordered product is also delayed.

For these reasons, an orderer, that is, a tourist who has ordered a product in a specific country while traveling around an area of the country, may not receive the desired product at a desired place at a proper time, thereby causing a fall in reliability of the country. This results in a reduction in the number of orders for products in the country.

### PRIOR ART DOCUMENT

### Patent Document

(Patent Document 0001) Korean Patent Application Publication No. 10-2013-0084274 [entitled “3-dimensinal Virtual Reality Shopping Mall”]

### SUMMARY

Various embodiments are directed to providing a base type order payment system and method for omni-channel shopping, which enable a tourist who travels around an area of each country to conveniently receive a payment-processed product based on a product order at a desired destination without delay.

In an embodiment, a base type order payment system for omni-channel shopping may include an order server constructed at a specific place, such as a hotel, a shopping center or an apartment house, and configured to provide a list of articles or products to a mobile terminal of an orderer in order to induce payment, base servers placed in respective areas and configured to receive order data from the order server, and a payment server configured to perform payment processing on the ordered product or article through a QR code included in the order data received from the base server.

In an example of the base type order payment system, the base type order payment system further includes a data transmission analysis server configured to determine and analyze the amount of transmission of the order data, transmitted to the base servers, and information on the order data in real time, and a data transmission control server configured to induce the order data to be uniformly transmitted to the base servers, based on the real-time information analyzed by the data transmission analysis server.

In an example of the base type order payment system, a data transmission and control algorithm is installed in the data transmission control server.

In an example of the base type order payment system, a kiosk terminal is used as a mobile terminal server if the order server is the mobile terminal server.

In an example of the base type order payment system, the kiosk terminal uses a contact type capacitive overlay method or a pressure type resistive overlay method as a scheme for preventing the delay of order processing attributable to a flood of order data.

In an example of the base type order payment system, the data transmission analysis server instructs the data transmission control server to transmit the order data to another base server closest to a base server onto which the amount of transmission of the order data is concentrated, based on a signal for inducing the remaining order data to be transmitted to the another base server.

In an embodiment, a base type order payment method for omni-channel shopping may include steps of a) providing, by an order server, a mobile app or member login including bio recognition for simple payment, b) presenting, to an orderer, products whose short-distance delivery is available and companies of the products, when the orderer orders a product using a mobile terminal, c) inputting orderer information related to a destination of the selected product, d) analyzing order data based on the input orderer information, e) transmitting and distributing the order data, f) performing payment processing on the product based on the order data, and g) completing the delivery of the payment-processed product.

In an example of the base type order payment method, in the step d) of analyzing order data based on the input orderer information, a data transmission analysis server analyzes whether the order data are concentrated onto and transmitted to any one base server, in a process of transmitting the order data to a base server closest to an address, based on the input of the orderer information presented to the mobile terminal of the orderer.

In an example of the base type order payment method, in the step e) of transmitting and distributing the order data, the data transmission analysis server allows the order data to be distributed by transmitting the remaining order data to another base server closest to the base server, based on a signal from a data transmission and control algorithm.

### BRIEF DESCRIPTION OF THE DRAWINGS

FIG. 1 is a schematic diagram illustrating a configuration of a base type order payment system for omni-channel shopping according to an embodiment of the present disclosure.

FIG. 2 is a block diagram illustrating a configuration of a base server 200 of FIG. 1.

FIG. 3 is a flowchart sequentially illustrating a base type order payment method for omni-channel shopping according to an embodiment of the present disclosure.

### DETAILED DESCRIPTION

The present disclosure should be interpreted as including even the scope of a right to a technical spirit through various modified embodiments. The embodiments are provided only to complete the present disclosure and to allow those skilled in the art to fully understand the category of the present disclosure. The present disclosure is only defined by the category of the claims.

Moreover, it is to be noted that drawings related to a prior art are omitted because the technical spirit of the present disclosure may be understood by the detailed description of the present disclosure.

A base type order payment system and method for omni-channel shopping according to an embodiment of the present disclosure will be described in detail below.

An omni-channel is a term in which “omni” meaning all and a “channel” meaning a distribution channel are combined, and is generally used as a meaning that all channels are used.

That is, the omni-channel indicates a service which enables a consumer to search for and purchase an article (or service) through various channels, such as online, offline, and a mobile. The omni-channel may provide a shopping environment in which characteristics of distribution channels are combined so that a consumer can feel as if he or she uses the same store through any channel.

A wireless Internet technology may include a wireless LAN, Wi-Max, WiBro, IEEE, Wi-Fi, Bluetooth, REID, ZigBee, ultrasonic communication, BLE, etc. A wired communication technology may include power line communication, USB communication, Ethernet, serial communication, an optical/coaxial cable, etc.

A communication unit may include technical standards or communication methods for mobile communication (e.g., a global system for mobile communication (GSM), code division multi access (CDMA), code division multi access 2000 (CDMA2000), enhanced voice-data optimized or enhanced voice-data only (EVDO), wideband CDMA (WCDMA), high speed downlink packet access (HSDPA), high speed uplink packet access (HSUPA), long term evolution (LTE), and long term evolution-advanced (LTE-A)).

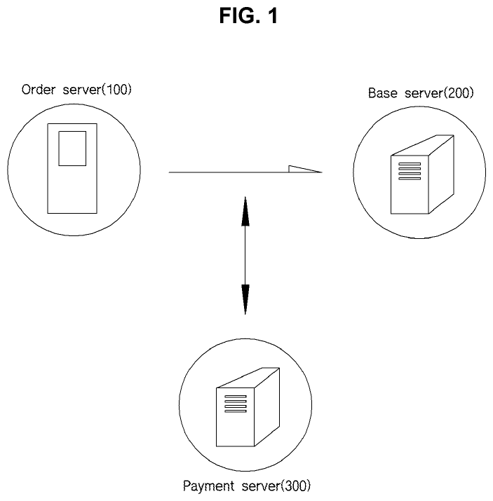

The base type order payment system for omni-channel shopping according to an embodiment of the present disclosure may be used to implement the transmission of data based on the technical background of the wireless Internet technology and the communication unit. For example, as illustrated in FIG. 1, the base type order payment system may be configured to include an order server 100 constructed in a specific place, such as a hotel, a shopping center, or an apartment house, and configured to provide a list of articles (or products) to orderers in order to induce payment, base servers 200 located in respective areas and configured to receive order data from the order server, and a payment server 300 configured to perform payment processing on the ordered product through a QR code or RFID included in the order data received from the base server.

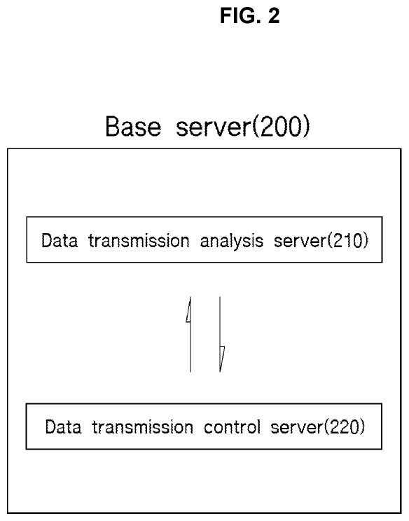

In the base type order payment system for omni-channel shopping, as illustrated in FIG. 2, for example, each of the base servers 200 may be configured to include a data transmission analysis server 210 configured to determine and analyze the amount of order data, transmitted to the base servers 200, and information thereon in real time, and a data transmission control server 220 configured to induce the order data to be uniformly transmitted to the base servers, based on the real-time information analyzed by the data transmission analysis server.

The order server 100 may be a fixed server or a movable type mobile terminal server. An orderer may check a list of products provided by the order server 100 in the state in which the orderer has accessed the order server 100 through his or her mobile terminal, and may select and order a product to be purchased. In some cases, an orderer may select and order a product by directly using the order server 100.

In particular, if the order server 100 is installed in the lobby or room of each hotel, that is, an accommodation in each country, a mobile terminal server that is advantageously movable may be used as the order server 100. A kiosk terminal that is installed in the lobby or room of each hotel and that enables a tourist, that is, a user to make a fast order through online shopping, may be used as the mobile terminal server.

In a product order process of users, order processing for products can be rapidly performed through the kiosk terminal. The reason why order processing for products can be rapidly performed is that the kiosk terminal is coupled to the data transmission analysis server 210 and the data transmission control server 220 for distributing order data, concentrated onto one base server, through the Internet.

In particular, the kiosk terminal may be a terminal configured using a contact type capacitive overlay method or a terminal configured using a pressure type resistive overlay method, as a scheme for preventing the delay of order processing attributable to a flood of order data.

The kiosk terminal using the contact type capacitive overlay method may be configured by coating, with transparent and special conductive metal (e.g., tin antimony oxide (TAO)), both sides of a screen made of tempered glass and heat-treated. When a voltage is applied to an edge of the screen, a high frequency generated from the edge of the screen is spread to all of the sensors of the screen. In this state, when the screen is touched by a finger, a receiver of the kiosk terminal detects a deformed waveform, and a controller of the kiosk terminal computes a corresponding location, thereby rapidly detecting a response to a fine constant voltage. Accordingly, the kiosk terminal may contribute to rapid processing for an order.

The kiosk terminal using the contact type capacitive overlay method has advantages in that it can detect a weak screen touch by responding to a fine constant voltage, can improve the robustness of the screen because tempered glass is coated with special metal, has a long lifespan, can produce the color of an original image due to high resolution and high transmittance of light, and has a very low error rate for order processing because a response speed upon touch is very fast.

Furthermore, the kiosk terminal using the pressure type resistive overlay method may have a structure in which a film made of a material having a resistant component is coated with a glass or transparent plastic plate, the film is covered with a film, and an insulating rod for maintaining a given interval between the two films is further positioned in order to prevent the two films from coming into contact with each other.

Accordingly, when a constant current flows into both ends of the resistant film, a voltage may be applied to both ends of the resistant film because the resistant film acts as a resistant body having a resistant component. In this state, when the upper film is touched by a finger, the upper film, preferably, a polystyrene film is bent and thus the two films are connected. A form, such as the parallel connection of pieces of resistance due to the resistant components of the two films, is made, thereby changing a resistance value. At this time, the voltage is changed by the current flowing into both ends, and the location of the touched finger can be identified based on a degree of a change in the voltage.

The kiosk terminal using the pressure type resistive overlay method can recognize a touch when the two films are brought into contact with each other, and may recognize a touch using another tool, for example, a ballpoint pen or a pointed object, in addition to a touch using a finger. The kiosk terminal using the pressure type resistive overlay method has advantages of an almost permanent lifespan (e.g., two million touches per point), a fast response speed upon touch (about 150 times or more per second), and a very low error rate.

As described above, the kiosk terminal has excellent accuracy and response speed compared to an infrared beam method, a surface acoustic wave method, an integral strain gauge method, and a piezo electric method because the kiosk terminal adopts the contact type capacitive overlay method or the pressure type resistive overlay method.

As described above, order data provided through the mobile terminal of an order, for example, the kiosk terminal of the order server 100 is transmitted to the base server 200. In this process, the data transmission analysis server 210 may instruct the order data to be transmitted to a base server closest to the address of the orderer included in the order data.

The data transmission analysis server 210 may instruct the data transmission control server 220 to transmit the order data to another base server closest to a base server onto which the amount of transmission of the order data is concentrated, based on a signal for inducing the remaining order data to be transmitted to another base server.

That is, the data transmission control server 220 can prevent degradation in operation performance of a system attributable to a system load phenomenon, which may occur in any one base server, by inducing order data, which may be concentrated onto any one base server, to be transmitted to another base server. Furthermore, the data transmission control server 220 can function to uniformly improve operation performance of base servers by inducing order data to be distributed to another base server.

The data transmission control server 220 may analyze and check the system specification capability of a base server onto which order data are concentrated, may predict whether operation performance of the base server will be degraded due to a load when the amount of transmission of order data is at a certain level, and may instruct the order data to be transmitted to another base server, adjacent to the corresponding base server, before the degradation in the operation performance of the corresponding base server reaches a threshold.

The data transmission control server 220 can prevent a phenomenon, in which order data are concentrated onto and transmitted to any one base server, using a program called a data transmission and control algorithm installed therein.

Accordingly, each of the base servers 200 constructed in each area or each area in each country can equally receive order data based on a transmission instruction from the data transmission analysis server 210 based on a signal according to the analysis and determination of the data transmission control server 220, which makes it possible to prevent a system load phenomenon in the base servers 200. As a result, the base servers 200 can smoothly transmit order data to the payment server 300 without performance degradation, and the payment server 300 can perform payment processing on the received order data based on such smooth transmission.

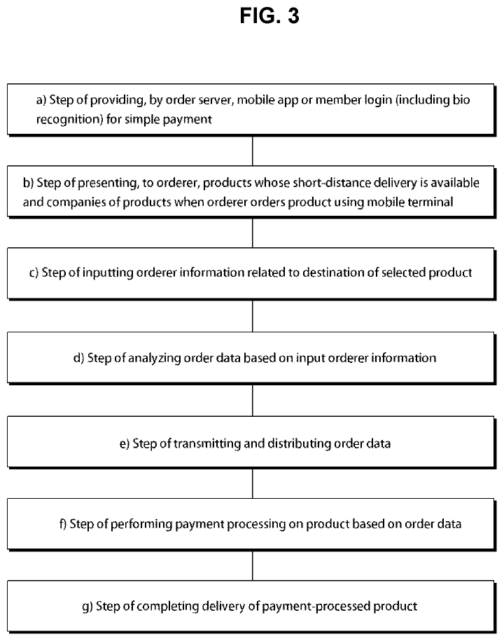

As illustrated in FIG. 3, A base type order payment method for omni-channel shopping according to an embodiment of the present disclosure may be configured to include steps of a) providing, by the order server, a mobile app or member login including bio recognition for simple payment, b) presenting, to an orderer, products whose short-distance delivery is available and companies of the products, when the orderer orders a product using a mobile terminal, c) inputting orderer information related to the destination of the selected product, d) analyzing order data based on the input orderer information, e) transmitting and distributing the order data, f) performing payment processing on the product based on the order data, and g) completing the delivery of the payment-processed product.

The step a) of providing, by the order server, a mobile app or member login (including bio recognition) for simple payment is a step of providing, by the order server, information on an app or member login (including bio recognition) to the mobile terminal of an orderer for simple payment for a product. A product can be ordered based on an app or member login (including bio recognition) provided by the order server.

The step b) of presenting, to an orderer, products whose short-distance delivery is available and companies of the products, when the orderer orders a product using a mobile terminal is a step of showing, to the mobile terminal, products whose short-distance delivery is available and the names of companies of the products in a product order process. That is, when the products whose delivery is available and the names of companies of the products are presented, a product whose delivery is not available is not ordered.

In the step c) of inputting orderer information related to the destination of the selected product, when the contents of input orderer information are activated in a process of selecting a product to be purchased and the company of the product among the products whose delivery is available and the names of companies of the products, presented to the mobile terminal of the orderer, using the mobile terminal of the orderer, contents related to the destination address of the orderer may be input.

In the step d) of analyzing order data based on the input orderer information, the data transmission analysis server may analyze whether the order data are concentrated onto and transmitted to any one base server, in a process of transmitting the order data to a base server closest to the address based on the input of the orderer information presented to the mobile terminal of the orderer.

In this case, if the order data are concentrated onto and transmitted to any one base server only, the data transmission and control algorithm installed in the data transmission control server determines whether the amount of transmission of the order data reaches a threshold, by analyzing the specifications of the any one base server and the amount of transmission of the order data. If it is determined that the amount of transmission of the order data reaches the threshold, the data transmission and control algorithm may notify the data transmission analysis server of a signal for inducing the remaining order data to be transmitted to another base server closest to the any one base server.

In the step e) of transmitting and distributing the order data, the data transmission analysis server may transmit the remaining order data to another base server closest to the any one base server, based on the signal from the data transmission and control algorithm. Accordingly, the order data can be distributed.

Accordingly, operation performance of the base servers is not degraded because a phenomenon, such as a traffic load attributable to a flood of order data, is prevented. Furthermore, the base servers can show operation performance faithful to specification information, and thus order data can be smoothly transmitted to the payment server.

In the step f) of performing payment processing on the product based on the order data, the payment server performs payment processing on the ordered products based on information on the order data received from the base servers.

The step g) of completing the delivery of the payment-processed product is a step of completing the delivery of the product as the purchased product is delivered to the address of the orderer provided through the mobile terminal of a delivery person.

As described above, according to embodiments of the present disclosure, there is an effect in that a tourist who travels around an area of a country can receive a product at a desired destination conveniently and rapidly without delivery delay by selecting the product sold in the area of the country online and paying for the product.

Furthermore, according to embodiments of the present disclosure, there are effects in that a user can conveniently purchase a product in a shopping process and receive a product through rapid payment processing on the product without limitation to the border or a place.

While various embodiments have been described above, it will be understood to those skilled in the art that the embodiments described are by way of example only. Accordingly, the disclosure described herein should not be limited based on the described embodiments.

What is claimed is:

1. A base type order payment system for omni-channel shopping, comprising:
an order server constructed at a specific place, such as a hotel, a shopping center or an apartment house, and configured to provide a list of articles or products to a mobile terminal of an orderer in order to induce payment;
base servers placed in respective areas and configured to receive order data from the order server; and
a payment server configured to perform payment processing on the ordered product or article through a QR code included in the order data received from the base server.

2. The base type order payment system of claim 1, further comprising:
a data transmission analysis server configured to determine and analyze an amount of transmission of the order data, transmitted to the base servers, and information on the order data in real time; and
a data transmission control server configured to induce the order data to be uniformly transmitted to the base servers based on the real-time information analyzed by the data transmission analysis server.

3. The base type order payment system of claim 2, wherein a data transmission and control algorithm is installed in the data transmission control server.

4. The base type order payment system of claim 3, wherein a kiosk terminal is used as a mobile terminal server if the order server is the mobile terminal server.

5. The base type order payment system of claim 4, wherein the kiosk terminal uses a contact type capacitive overlay method or a pressure type resistive overlay method as a scheme for preventing the delay of order processing attributable to a flood of order data.

6. The base type order payment system of claim 5, wherein the data transmission analysis server instructs the data transmission control server to transmit the order data to another base server closest to a base server onto which an amount of transmission of the order data is concentrated, based on a signal for inducing remaining order data to be transmitted to the another base server.

7. A base type order payment method for omni- channel shopping, comprising steps of:
a) providing, by an order server, a mobile app or member login including bio recognition for simple payment;
b) presenting, to an orderer, products whose short- distance delivery is available and companies of the products when the orderer orders a product using a mobile terminal;
c) inputting orderer information related to a destination of the selected product;
d) analyzing order data based on the input orderer information;
e) transmitting and distributing the order data;
f) performing payment processing on the product based on the order data; and
g) completing the delivery of the payment-processed product.

8. The base type order payment method of claim 7, wherein in the step d) of analyzing order data based on the input orderer information, a data transmission analysis server analyzes whether the order data are concentrated onto and transmitted to any one base server, in a process of transmitting the order data to a base server closest to an address, based on the input of the orderer information presented to the mobile terminal of the orderer.

9. The base type order payment method of claim 8, wherein the step e) of transmitting and distributing the order data, the data transmission analysis server allows the order data to be distributed by transmitting remaining order data to another base server closest to the base server, based on a signal from a data transmission and control algorithm.
